(19) United States
(12) Patent Application Publication
(10) Pub. No.: US 2026/0127378 A1
(43) Pub. Date: May 7, 2026

(54) METHOD AND SYSTEM FOR EVALUATING MACHINE GENERATED CONTENT VIA KNOWLEDGE GRAPH

(71) Applicant: Verizon Patent and Licensing Inc., Basking Ridge, NJ (US)

(72) Inventors: Chandnika R, Chennai (IN); Praveenkumar Chandrasekaran, Chennai (IN)

(73) Assignee: Verizon Patent and Licensing Inc., Basking Ridge, NJ (US)

(21) Appl. No.: 18/934,655

(22) Filed: Nov. 1, 2024

(51) Int. Cl. G06F 40/30

(52) U.S. Cl. CPC G06F 40/30

(57) ABSTRACT

The present teaching relates to evaluating large language model (LLM) generated responses with explainable assessment. A knowledge graph (KG) is constructed based on entities and relations detected from information representing ground truth via KG triplets, each of which represents a ground truth fact. When a trained LLM generates a response for an input query, response triplets are identified and matching KG triplets for each response triplet are identified. Semantic similarities between response triplets and matching KG triplets are determined and used to evaluate the response with an explainable assessment obtained based on the semantic similarity between response triplets and matching KG triplets.

### BACKGROUND

In recent years, generative artificial intelligence (AI) has been applied to develop different products. The backend basis for the operation of a generative AI product includes a large language model (LLM) trained for either a generic purpose or a specific purpose associated with a particular type of applications. For example, some LLMs may carry on a dialogue with a user, answering questions from the user with responses and/or creating content at the request of the user. With the increasingly popular use of such generative AI products in different scenarios, issues have been raised with respect to the quality of the content output, such as accuracy, consistency and hallucinations, from such products.

### BRIEF DESCRIPTION OF THE DRAWINGS

The methods, systems and or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates a traditional setting of utilizing an LLM to support a Q&A engine to carry on a human machine communication;

FIG. 2A depicts an exemplary system diagram of a framework that uses an LLM in a human machine communication with a fact check mechanism based on known knowledge to provide an interpretable evaluation of the LLM generated content, in accordance with an embodiment of the present teaching;

FIG. 2B is a flowchart of an exemplary process of a framework that uses an LLM in a human machine communication with a fact check mechanism based on known knowledge to provide an interpretable evaluation of the LLM generated content, in accordance with an embodiment of the present teaching;

FIG. 3A shows exemplary types of information collected, processed, and represented as ground truth for fact check, in accordance with an embodiment of the present teaching;

FIG. 3B depicts an exemplary system diagram of a knowledge graph constructor for creating a representation of known knowledge as ground truth to facilitate fact check of LLM generated content, in accordance with an embodiment of the present teaching;

FIG. 3C is a flowchart of an exemplary process of a knowledge graph constructor for creating a representation of known knowledge as ground truth to facilitate fact check of LLM generated content, in accordance with an embodiment of the present teaching;

FIG. 4A depicts an exemplary system diagram of an LLM response evaluation engine, in accordance with an embodiment of the present teaching;

FIG. 4B is a flowchart of an exemplary process of an LLM response evaluation engine, in accordance with an embodiment of the present teaching;

FIG. 5 is an illustrative diagram of an exemplary mobile device architecture that may be used to realize a specialized system implementing the present teaching in accordance with various embodiments; and

FIG. 6 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

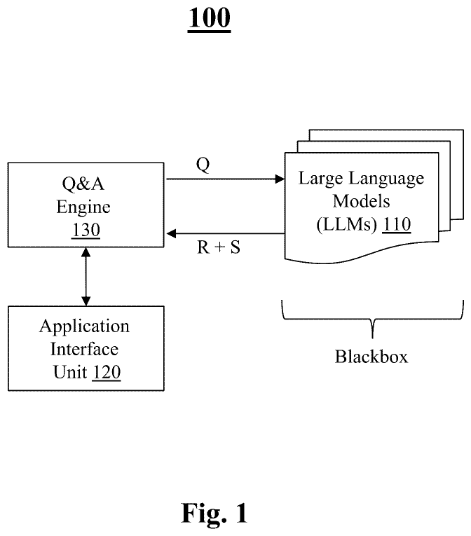

With the recent increased popularity of generative AI products, more and more companies adopt such products to development various applications for different purposes. FIG. 1 illustrates an exemplary scheme 100 of utilizing LLMs previously trained to drive a Q&A engine 130. In this example, the previously trained LLMs 110 is used as a response generation mechanism to provide a response R to a question Q, raised by someone via an application interface unit 120, which may serve as an interface to users of any application. For example, a service company may provide 24/7 online customer support. In this example, the application may correspond to a human machine dialogue system and the application interface unit 120 may provide an online dialogue box to allow a customer to type in their questions. In this setting, a customer may pose a question Q via the interface unit 120 to the Q&A engine 130, which may pass on the question to the LLMs and receive a response R therefrom before it delivers the response to the interface unit 120.

A different example may be applying LLM in a network management application. In this example, previous logs related to network management may be used to train LLM to produce a predicted diagnosis of network malfunctions and corresponding preventative measure(s) based on given input describing the current states of different network components. In this case, the application interface unit 120 may be implemented to gather current network operational data and provided to the Q&A engine 130. The Q&A engine 130 may present the current network operational data according to some organization as needed and provide to the LLMs 110. With such input, the LLMs 110 may then generate the response with respect to the current network operational states predicting certain network malfunctions that may occur based on past knowledge and corresponding potentially useful measures to prevent the malfunctions.

In different use cases of generative AI, it is important that the LLM produces responses that are factually accurate, logically consistent, and free of hallucinations with respect to given inputs. To address this issue, efforts have been made to provide some evaluation for LLM generated content. Current solutions rely on generative AI to perform the assessment. For example, each response produced by LLM may be provided with a confidence score, indicative of the quality of the response. In this implementation, as both the response and the evaluation thereof are generated by the same LLM, the quality assessment of the LLM response is inherently unreliable. In addition, a confidence score in general reflects only the confidence of the LLM in generating the response given what the LLM learned during its training. Such an evaluation approach is biased, incapable of an independent unbiased evaluation on the response as to, e.g., its accuracy, consistency, objectivity, and robustness. Furthermore, although some metric(s) such as a confidence score may still represent some evaluation, it does not offer any meaningful interpretation or impression as to what quality aspect of the response the metrics actually represent so that a user may further determine whether the response is trustworthy or not.

The present teaching discloses a scheme to evaluate an LLM generated content such as a response via an independent means to indicate, in an interpretable manner, whether the LLM generate content is accurate with respect to facts, whether it is consistent with respect to logic according to some domain knowledge, and whether it is free of hallucination. In this independent evaluation scheme according to the present teaching, the evaluation is performed independent of the LLM that generates the content so that it is unbiased. Knowledge in some relevant domain may be analyzed to identify how different entities are related as domain knowledge and construct graphs capturing such knowledge as ground truth or associated facts. Such knowledge graphs representing domain specific facts may serve as the basis for fact check directed to content generated by LLMs.

For example, if a company utilizes LLMs to support a Q&A system for customer service, relevant domain knowledge may include the types of services provided, terms of such services, and usual issues raised by customers, and resolutions thereof. Knowledge graphs may be created to represent such domain knowledge as ground truth and may be adaptively updated whenever there are changes. Past communications may be used for training LLMs for answering questions from customers. Each LLM generated response may be fact checked as to its accuracy and consistency to ensure free of hallucination. As the check is carried out against concrete facts represented in the knowledge graphs, such an evaluation result can be interpreted based on the concrete fact check outcome.

According to the present teaching, a knowledge graph may include connected triplets, each of which represent a pair of entities linked by a specific relationship. For example, “service provider A offers service B, and the price starts at C” may be a piece of knowledge related to a company. In this example, there are three entities, namely service provider A, service B, and price C, and two relationships, including “offers” and “starts at.” Entities A and B are related by “offers,” and entities B and C are related by “starts at,” respectively. Given that, two triplets may be constructed as, [A, offers, B] and [B, starts at, C] and they are linked by the common entity B. Triplets may be constructed based on known knowledge and they are linked by entities and the knowledge is captured by a web of triplets, representing various relationship between and among different entities.

Such a knowledge graph may be used as the basis for evaluating an LLM generated response. To do so, for each LLM response, it may be analyzed to detect entities and relations. Triplet(s) may also be created based on the response. Triples from an LLM generated response may then be matched against the knowledge graph to identify matching or related knowledge graph (KG) triplets. In some embodiments, the match may be identified based on either an exact or an inexact match. For each triplet identified from an LLM response, there may be more than one matching KG triplets, each of which may be evaluated separately and may provide a potential basis for an explanation of the overall evaluation result. In some embodiments, each matching pair may be evaluated in terms of their similarity (e.g., semantic similarity) o derive a metric representing the degree of similarity. For a response triplet with multiple matched KG triplets, the respective similarity assessment for different matching pairs may be aggregated to produce an integrated score measuring the overall similarity between the LLM response and the knowledge from the graph.

For instance, if a question provided to an LLM is “does company A have service B” and the LLM generates a response “A provides service B,” this response may be evaluated as a good response because it is consistent with the triplet [A, offers, B] represented in the knowledge graph. However, if the LLM generates “A offers service B which starts at price D,” the response may be evaluated as inaccurate if C≠D because it is inconsistent with triplet [B, starts at, C] represented by the knowledge graph. In this case, the specific reason why the LLM response is considered as inaccurate can be explicitly provided according to the assessment based on the knowledge graph. In this manner, not only an LLM generated response can be assessed independent of the generative AI technique used for LLM, but the evaluation result also obtained according to the present teaching is concretely interpretable or explainable.

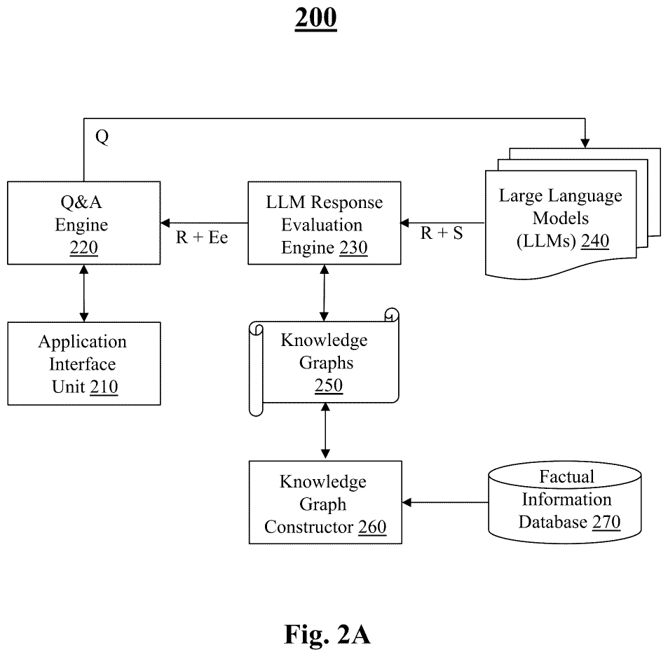

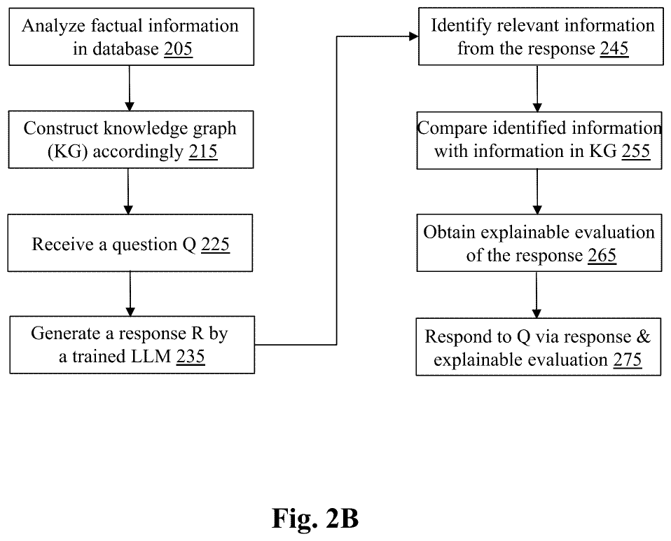

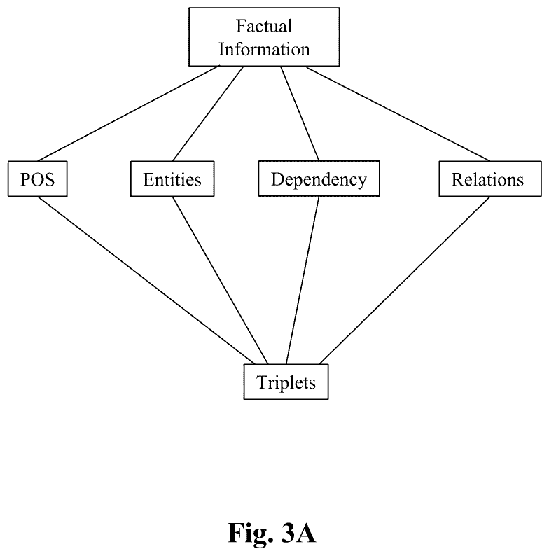

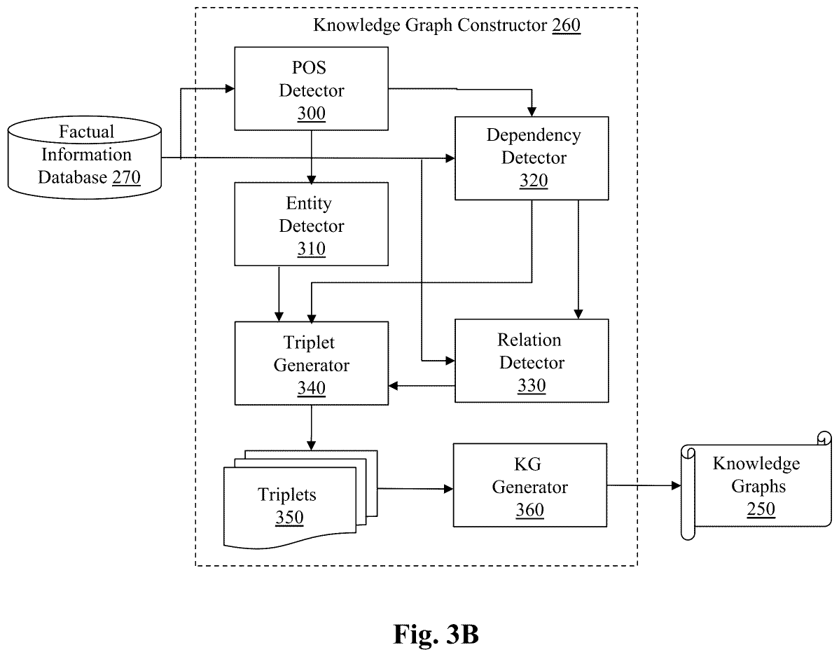

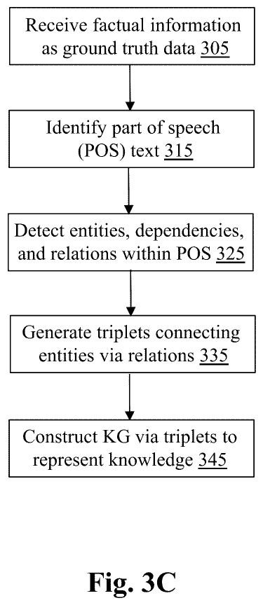

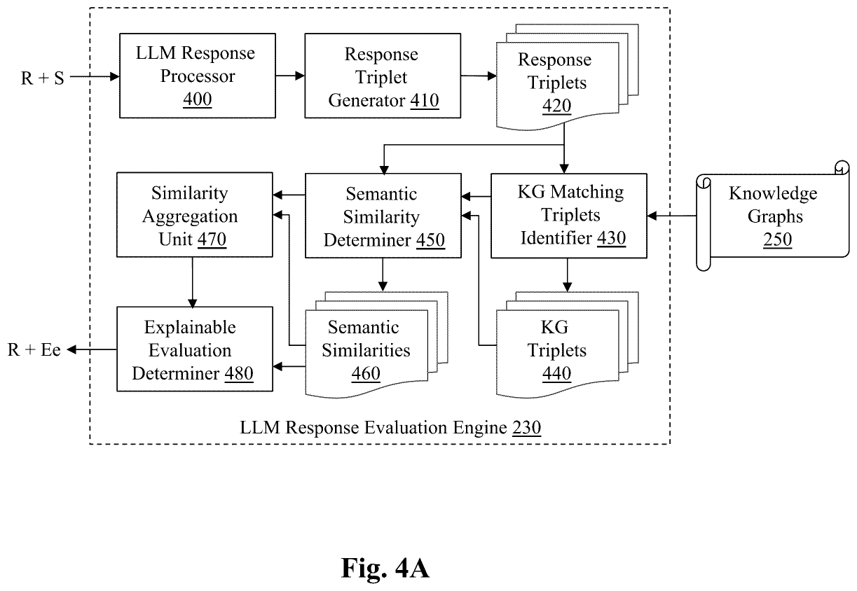

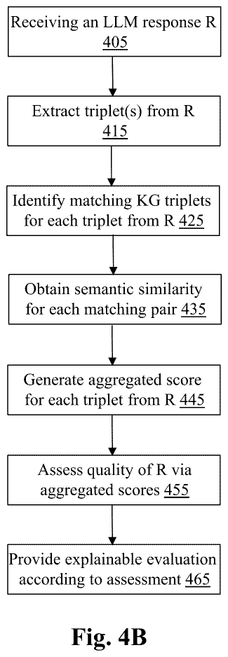

FIG. 2A depicts an exemplary system diagram of a framework 200 that uses an LLM in a human machine communication with an independent evaluation mechanism based on known knowledge with an interpretable assessment as to quality of the LLM generated content, in accordance with an embodiment of the present teaching. This illustrated framework 200 comprises an application interface unit 210, a Q&A engine 220, LLM models 240, as well as an independent LLM response evaluation engine 230, located between the large language models or LLMs 240 and the Q&A engine 220 to provide, for each LLM generated response A, an explainable evaluation (Ee) as to the quality of A. To support the LLM response evaluation engine 230, the framework 200 further includes a knowledge graph constructor 260 that derives knowledge graphs 250 based on factual information stored in a factual information database 270. Compared with the typical traditional approach to assessing an LLM generated response as shown in FIG. 1, the framework 200 provides an LLM generated response evaluation scheme that is independent of generative AI based on factual information to perform fact check and derive interpretable evaluation result. Details related to the LLM response evaluation engine 230 and the knowledge graph constructor 260 are provided with reference to FIGS. 3A-4B.

FIG. 2B is a flowchart of an exemplary process of the framework 200 for LLM based human machine communication with independent evaluation based on known knowledge to provide an interpretable assessment of the LLM generated content, in accordance with an embodiment of the present teaching. In operation, the knowledge graph constructor 260 analyzes, at 205, factual information retrieved from database 270 and constructs, at 215, the knowledge graph (KG) 250, which represents the ground truth in a relevant domain and is to be used as such in evaluating an LLM generated response. When a question Q is received, at 225, by the Q&A engine 220, it is forwarded to the LLMs 240 that generates, at 235, a response R (with e.g., a confidence score S) with respect to the question. The response R from the LLMs 240 is output to the LLM response evaluation engine 230 to assess the quality of R. To do so, the LLM response evaluation engine 230 may identify, at 245, representative information such as triplets from A. For each triplet extracted from the LLM generated response, the LLM response evaluation engine 230 may compare, at 255, it with triplets in the knowledge graphs 250 and extract those KG triplets that match with the triplet from the response. Based on such matching triplets, the LLM response evaluation engine 230 may then obtain, at 265, explainable evaluation Ee with respect to A and provide, at 275, the LLM generated response A with explainable evaluation Ee as a response to the question Q.

The present teaching may be applied in a variety of applications. For example, automatically evaluating LLM generated content to provide an assessment with explanations may be used in automated virtual customer services via chatbots. In this type of application, a customers may ask a question and generative AI with an LLM may answer customer's question. The independent LLM response evaluation scheme according to the present teaching may be used to assess the response from the LLM with an explanation that interpret the underlying reason(s) for the assessment when needed. For instance, a customer asks whether company A offers service B with a monthly cost lower than a certain amount C. When the LLM generates a response stating that company A provides service B with a price starts at D. If D>C, although the LLM generated response does answer the question on whether A provides service B, the response is not quite accurate because the service B from A does not satisfy what the customer asks for (which should have a cost lower than C). In this case, the fact check conducted via the present teaching using independent evaluation based on ground truth knowledge will reveal which part of the response is accurate and correct and which part is not, i.e., providing interpretable evaluation (as compared with a confidence score as in the traditional systems).

Another exemplary application of the evaluation scheme according to the present teaching is for network performance monitoring, anomaly detection, and preemptive avoidance. In this application, the operational data from a network service provider may be monitored and collected. Such operational data may include network components operational states, malfunction logs with localized diagnosis and timing, measures deployed to either prevent or fix malfunctions, management changes based on past experiences and results thereof, etc. The knowledge graph constructed from such network operational data captures, via various types of relationships among related nodes, via, e.g., hardware connections, information flows, chain effect among network components in the network, and how the consequences of certain measures when deployed. An LLM may be trained based on past collected network operational data to predict, when information about the current operational state of a network is received, malfunctions that may occur and the location(s) in the network where the problems may emerge. During the operation of a network, when real-time operational data is received, it may be provided to the LLM to predict potential problems/malfunctions and possible preemptive measures to deploy to minimize the problems. In this application, the input to the LLM is textual information recording the network operation states and the output from the LLM may include predictions of problems and measures to be employed. The independent evaluation scheme of the present teaching may be applied to assess the quality of the LLM output against the knowledge graph constructed with interpretable explanation as to why certain parts of the LLM output may be inaccurate or inconsistent with the ground truth knowledge.

FIG. 3A shows exemplary types of factual information that may be collected, analyzed, and represented as ground truth for evaluating an LLM generated response, in accordance with an embodiment of the present teaching. As illustrated, factual information may include, but is not limited to, portions of speech (POS), entities included in POS, dependencies existing among entities, and relations that entities are related to each other. The factual information may correspond to different documents or transcripts about, e.g., a product and services associated thereof. Information about a product may include its specification, its user manual, its advertisements, its sale terms, and one or more services provided for the product, the terms of each service, etc. From such raw information, factual information may be extracted therefrom. In some embodiments, the types of factual information extracted from raw data may be determined based on the needs of application in hand. For instance, if the application is related to network management and the goal is to train an LLM to predict malfunctions based on operational state information reported from different network components, where the LLM may be trained based on past network operation logs and engineering notes. In this application, as the goal is to predict network malfunctions, factual information to be extracted from raw information (which may be specification of the network components, connections thereof, past reported malfunctions, and treatments thereof, etc.) may be defined to include components in the network, how they are connected, information transmitted between and among network components, and different operational states with labels including normal or abnormal, and specific network components'operational states prior to recorded malfunctions, etc. Such extracted factual information may then be used by the knowledge graph constructor 260 to obtain various triplets forming a web or graph to represent the ground truth in managing the operation of the network.

FIG. 3B depicts an exemplary system diagram of the knowledge graph constructor 260 for creating a representation of known knowledge to serve as ground truth to facilitate evaluation of LLM generated content, in accordance with an embodiment of the present teaching. In this illustration, the knowledge graph constructor 260 is provided for establish the knowledge graphs 250 based on the exemplary types of factual information shown in FIG. 3A. It is noted that it is merely for the purpose of illustration instead of as a limitation. Depending on the types of factual information relevant to each application, the knowledge graph constructor 260 may be accordingly implemented to build a knowledge graph based on any types of factual information relevant to the application to serve the goal of the application.

In this illustrated implementation, the knowledge graph constructor 260 comprises a POS detector 300, an entity detector 310, a dependency detector 320, a relation detector 330, a triplet generator 340, and a KG (knowledge graph) generator 350. FIG. 3C is a flowchart of an exemplary process of the knowledge graph constructor 260 for creating a ground truth representation of known knowledge to facilitate fact check of LLM generated content, in accordance with an embodiment of the present teaching. In operation, upon receiving, at 305, the factual information from 270, the POS detector 300 may be provided to identify, at 315, portions of speech from the received information as the basis to identify other related information, from which different types of relevant information may be detected at 325. For example, the entity detector 310 may be provided for recognizing entities included in the factual information or in POSs detected. Such detected entities may be represented as nodes in a knowledge graph. The dependency detector 320 may be provided to extract dependencies among different entities. For instance, a service plan may include multiple sub-services which are dependencies of the service plan. In some applications, such dependency detected may be exploited as useful knowledge to reveal other implicit relations among entities. In this example, if the umbrella service plan has a limit on a service period, then all the sub-services under the umbrella inherently are subject to the same limitation. In this case, the detected dependency may be useful to infer the limitations applicable to the sub-services so that such implicit relation may be revealed explicitly in a knowledge graph.

The relation detector 330 may be provided to detect any relation that may be embedded in the factual information. As illustrated herein, if company A (an entity) offers a service B (an entity), then A and B have a relation signified by “offers.” In addition, if the price for service B starts at price C, then service B (an entity) and price C (an entity) are related by a relation signified by “starts at.” In detecting such relations, each entity may be involved in multiple relations and different relations may link multiple entities via indirect relations. For example, in the above example, entity “company A” is indirectly linked to entity “price C” via a common related entity “service B.” Such detected relations may then be used by the triplet generator 340 to generate, at 335, various triplets 350, which are the used by the KG generator 360 to generate, at 345, the knowledge graphs 250. Different triplets may be connected via common entities so that the triplets generated based on the factual information form a web of related entities based on different relations that represents the ground truth of the facts extracted from the factual information.

As discussed herein, based on the knowledge graphs 250, each LLM generated response in response to a question from the Q&A engine 220 may be evaluated for its accuracy, consistency, and hallucination in accordance the ground truth facts represented by the knowledge graphs 250. In addition, the ground truth facts matched with different aspects of each LLM generated response (identified during the evaluation) may be the basis for interpreting the reasonableness or unreasonableness of different aspects of the LLM generated response, providing explainable evaluation according to the present teaching. FIG. 4A depicts an exemplary system diagram of the LLM response evaluation engine 230, in accordance with an embodiment of the present teaching. In this illustrated embodiment, the LLM response evaluation engine 230 comprises an LLM response processor 400, a response triplet generator 410, a KG matching triplet identifier 430, a semantic similarity determiner 450, a similarity aggregation unit 470, and an explainable evaluation determiner 480.

As discussed herein, to evaluate an LLM generated response, triplets may be identified from the LLM generated response. For each of the response triplets, one or more matching KG triplets may be identified from the knowledge graphs 250 via either exact or inexact matching. The semantic similarity between a pair of a response triplet and a matching KG triplet may be determined to indicate how accurate and consistent the response triplet is when compared with the matching ground truth triplet (KG triplet). The higher the similarity, the more accurate the response triplet is. That is, the process of determining the semantic similarity of a pair or matching triplets corresponds to fact check.

In some embodiments, the semantic similarity of a pair of triplets may be determined based on feature vectors of the respective components in the triplets. In some embodiments, such feature vectors may correspond to embeddings obtained by some previously machine trained model(s). Either feature vectors or embeddings are obtained for each part of a triplet. For instance, a response triplet may be [X1, X2, X3] with X1 may corresponding to subject, X3 the object, and X2 the relation connecting the subject with the object. In this example, the subject X1 may be characterized by a feature vector or embeddings, the object may be separately represented by its feature vector/embeddings. Similarly, a KG matching triplet may be [T1, T2, and T3], where T1 may correspond to the subject, T3 the object, and T2 a relation connecting the subject T1 with the object T3. Individual parts may separately be characterized by their respective feature vectors/embeddings.

To determine the similarity between a response triplet, e.g., [X1, X2, X3] and a KG triplet [T1, T2, T3], each corresponding part may need to match. That is, with this example, T1 matches X1, T3 matches X3, and T2 matched X2. Assume that each component in a triplet is represented by a vector (either a feature vector or embeddings) V, i.e., V(X1), V(X2), V(X3), V(T1), V(T2), and V(T3), then the similarity of the two triplets may be determined based on the similarity between V(X1) and V(T1), the similarity between V(X2) and V(T2), and the similarity between V(X3) and V(T3). A high proportion of high similarity metrics may indicate that the triplet represents a high accuracy as it is in good alignment (or quite consistent) with the ground truth represented by the matching KG triplet. On the other hand, a poor semantic similarity in any part of a triplet reveals inconsistency between the response triplet and the matching KG triplet, indicative of inaccuracy or even hallucination in the LLM generated response. That is, the assessment to each part of the triple may be used individually as the basis to interpret the evaluation result. In the meantime, such individual assessment may be aggregated as an evaluation on the degree of similarity between a response triplet and a matching KG triplet.

In some implementations, the assessment with respect to different parts of a response triplet may be used to improve the efficiency of the evaluation. For instance, if the subject X1 stated in a response has no matching KG triplet with a similar subject T1, the response may be considered as having no matching KG ground truth. If at least one KG triplet is found with the same or similar subject, then next step is to identify those KG triplets with the same or similar object as X3. Only if matching KG triplets with the same or similar subject and object as the response subject X1 and object X3 are found, then further processing is performed to identify matching KG triplets that also have similar or the same relation as X2.

In some embodiments, upon identifying a matching KG triplet, the vectors for different parts of a triplet (either a response triplet or a KG triplet) may be concatenated to form a super vector, e.g., SV (X1, X2, X3) and SV (T1, T2, T3). Given that, the similarity between two super vectors may be determined. The similarity between two vectors (either a feature vector or a concatenated super vector) may be obtained based on any of available approaches. For example, a cosine of two vectors may be used. In some embodiments, the similarity between two vectors may be determined based on the Euclidean distance between their respective centroids. Any other metric to measure the similarity between two vectors may be used.

In some situations, a triplet from an LLM generated response may have multiple matching KG triplets, yielding multiple semantic similarities. In some embodiments, to derive an assessment for the triplet, such semantic similarities due to multiple matching KG triplets may also be aggregated to obtain an integrated semantic similarity indicating the consistency between the response and the ground truth. However, as each individual assessment performed with respect to each of the matching KG triplets is preserved, they may all be used as the basis for providing explanation of the evaluation. Similarly, if an LLM generated response has multiple triplets, the semantic similarities between individual triplets from the response and their respective matching KG triplet(s) may also be aggregated to obtain an overall assessment as to the semantic similarity between the LLM generated response and the ground truth knowledge as represented by the knowledge graph.

FIG. 4B is a flowchart of an exemplary process of the LLM response evaluation engine 230, in accordance with an embodiment of the present teaching. In operation, when an LLM generated response A is received at 405, the LLM response processor 400 may be provided to process the response R (e.g., identify entities, dependency, and relations). The processed result may be provided to the response triplet generator 410 to extract, at 415, response triplets 420 associated with the LLM generated response R. With respect to each of the response triplets in 420, the KG matching triplet identifier 430 may be provided to identify, at 425, KG triplet(s) (440 in FIG. 4A) that match with the response triplet. As discussed herein, the matching may be performed via exact or inexact matching. In some embodiments, the process of identifying matching KG triplets may also involve the use of a synonym dictionary or other similar means to capture KG triplets that, although different words may be used, nevertheless represent the same meaning as that in a response triplet. For instance, a response triplet may have [A, provides, B] and a KG triplet may have [A, offers, B] and they may be recognized as matching pair when word “provides” is considered as a synonym as “offers.”

With the matching KG triplets 440 identified with respect to the response triplets 420, the semantic similarity determiner 450 is provided to obtain, at 435, a semantic similarity score for each matching pair of response/KG triplets and store such semantic similarity scores 460 for aggregation, which is performed by the similarity aggregation unit 470 at 445. Based on the individual semantic similarities 460 and aggregated semantic similarities from the similarity aggregation unit 470 with respect to different response triplets, the explainable evaluation determiner 480 assesses, at 455, the overall quality of R with explainable evaluation result Ee and provides, at 465, the LLM generated response R with Ee. Both the aggregated semantic similarity scores for different response triplets and their individual semantic similarities on different matching pairs may be utilized by the explainable evaluation determiner 480 to provide interpretation of Ee. For example, if LLMs 240 generates a response on a question Q “does company A provides service B?” which states “Yes, company A provides service B with a price starting at D,” the evaluation according to the present teaching may yield an explanation that the quality of the LLM generated response is reasonable because the fact check indicates that company A does provide service B but the response is not completely accurate because the price D is not correct.

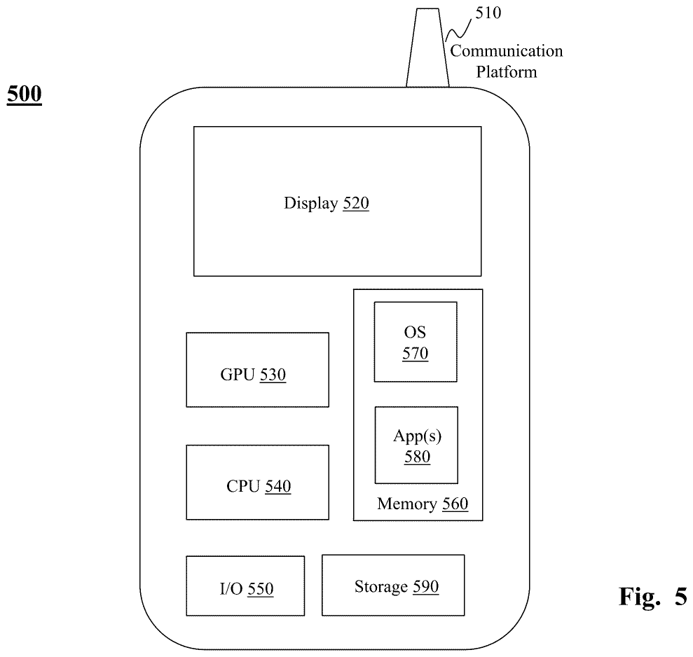

FIG. 5 is an illustrative diagram of an exemplary mobile device architecture that may be used to realize a specialized system implementing the present teaching in accordance with various embodiments. In this example, the user device on which the present teaching may be implemented corresponds to a mobile device 500, including, but not limited to, a smart phone, a tablet, a music player, a handled gaming console, a global positioning system (GPS) receiver, and a wearable computing device, or a mobile computational unit in any other form factor. Mobile device 500 may include one or more central processing units (“CPUs”) 540, one or more graphic processing units (“GPUs”) 530, a display 520, a memory 560, a communication platform 510, such as a wireless communication module, storage 590, and one or more input/output (I/O) devices 550. Any other suitable component, including but not limited to a system bus or a controller (not shown), may also be included in the mobile device 500. As shown in FIG. 5, a mobile operating system 570 (e.g., iOS, Android, Windows Phone, etc.) and one or more applications 580 may be loaded into memory 560 from storage 590 to be executed by the CPU 540. The applications 580 may include a user interface or any other suitable mobile apps for information exchange, analytics, and management according to the present teaching on, at least partially, the mobile device 500. User interactions, if any, may be achieved via the I/O devices 550 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

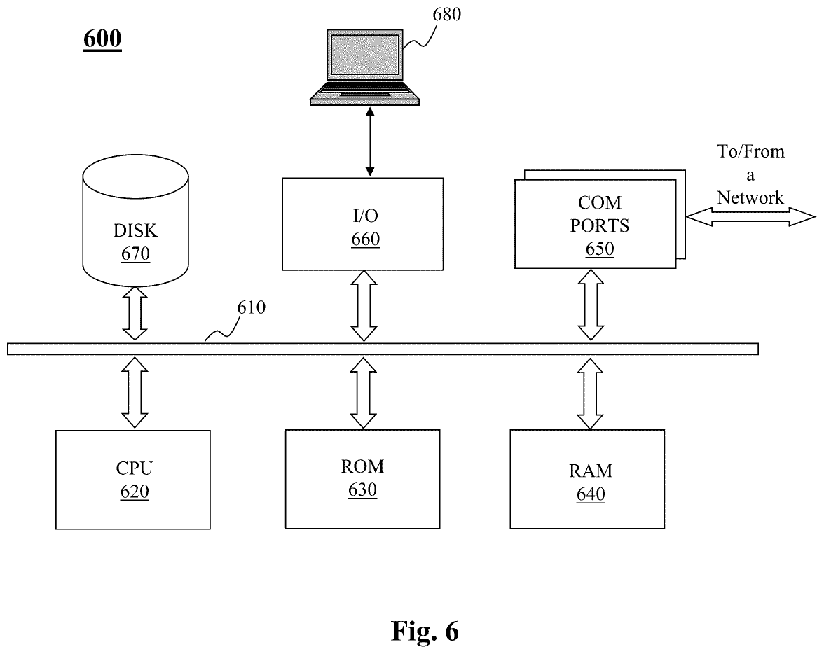

FIG. 6 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 600 may be used to implement any component or aspect of the framework as disclosed herein. For example, the information processing and analytical method and system as disclosed herein may be implemented on a computer such as computer 600, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 600, for example, includes COM ports 650 connected to and from a network connected thereto to facilitate data communications. Computer 600 also includes a central processing unit (CPU) 620, in the form of one or more processors, for executing program instructions. The exemplary computer platform includes an internal communication bus 610, program storage and data storage of different forms (e.g., disk 670, read only memory (ROM) 630, or random-access memory (RAM) 640), for various data files to be processed and/or communicated by computer 600, as well as possibly program instructions to be executed by CPU 620. Computer 600 also includes an I/O component 660, supporting input/output flows between the computer and other components therein such as user interface elements 680. Computer 600 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
receiving information representing ground truth;
detecting entities and relations from the information;
constructing a knowledge graph (KG) based on knowledge triplets, each of which characterizes a relation connecting two of the entities in the information and represents a ground truth fact;
receiving an input query;
generating, via a previously trained large language model (LLM), a response with respect to the input query;
identifying, from the response, one or more response triplets, each of which includes two entities via a relation;
with respect to each of the one or more response triplets,
determining, if at least one matching KG triplet exists in the knowledge graph, semantic similarity between the response triplet and the at least one matching KG triplet;
evaluating the response based on the semantic similarities between the one or more response triplets and respective matching KG triplets to generate an assessment; and
providing the response with the assessment including an explanation of the assessment obtained based on the semantic similarity between each response triplet and its matching knowledge triplet.

2. The method of claim 1, wherein the constructing the knowledge graph comprises:
with respect to the entities and the relations detected from the information,
recognizing a subject entity and an object entity from the detected entities that are related according to one of the detected relations, and
creating a KG triplet with the subject entity, the relation that connects the subject and object entities, and the object entity; and
forming the knowledge graph based on the KG triplets.

3. The method of claim 1, wherein
the LLM is trained based on network management data;
the entities and relations are network entities and relations; and
the generated response from the LLM is a network anomaly determination.

4. The method of claim 2, wherein
each of the response triplets includes a subject entity, an object entity, and a connecting relation linking the subject and object entities according to the response; and
the matching KG triplet is identified when:
the subject entity in the matching KG triplet is similar to the subject entity in the response triplet,
the object entity in the matching KG triplet is similar to the object entity in the response triplet, and
the connecting relation in the matching KG triplet is similar to the connecting relation in the response triplet,
wherein the similarity is determined based on feature representations of the subject and the object entities and the connecting relations in both the response triplet and the matching KG triplet.

5. The method of claim 1, wherein the determining the semantic similarity between the response triplet and the at least one matching KG triplet comprises:
determining, with respect to each of the at least one matching KG triplet, semantic similarity between the response triplet and the matching KG triplet;
aggregating the semantic similarities determined with respect to different matching KG triplets to derive the semantic similarity between the response triplet and relevant ground truth facts represented by the at least one matching KG triplet.

6. The method of claim 1, wherein the evaluating the response comprises:
accessing one or more semantic similarities, each of which is determined between each of the one or more response triplets and at least one matching KG triplet;
aggregating the one or more semantic similarities to generate an overall semantic similarity representing the assessment of the response;
creating the explanation for the assessment based on at least one of
the one or more semantic similarities associated with the one or more response triplets, and
the semantic similarity between each of the one or more response triplets and each of its matching KG triplet.

7. The method of claim 6, wherein the explanation for the assessment is further created based on the semantic similarity between each part of each of the one or more response triplets and the corresponding part of each matching KG triplet.

8. A machine-readable and non-transitory medium having information recorded thereon, wherein the information, when read by the machine, causes the machine to perform the following steps:
receiving information representing ground truth;
detecting entities and relations from the information;
constructing a knowledge graph (KG) based on knowledge triplets, each of which characterizes a relation connecting two of the entities in the information and represents a ground truth fact;
receiving an input query;
generating, via a previously trained large language model (LLM), a response with respect to the input query;
identifying, from the response, one or more response triplets, each of which includes two entities via a relation;
with respect to each of the one or more response triplets,
determining, if at least one matching KG triplet exists in the knowledge graph, semantic similarity between the response triplet and the at least one matching KG triplet;
evaluating the response based on the semantic similarities between the one or more response triplets and respective matching KG triplets to generate an assessment; and
providing the response with the assessment including an explanation of the assessment obtained based on the semantic similarity between each response triplet and its matching knowledge triplet.

9. The medium of claim 8, wherein the constructing the knowledge graph comprises:
with respect to the entities and the relations detected from the information,
recognizing a subject entity and an object entity from the detected entities that are related according to one of the detected relations, and
creating a KG triplet with the subject entity, the relation that connects the subject and object entities, and the object entity; and
forming the knowledge graph based on the KG triplets.

10. The medium of claim 8, wherein
the LLM is trained based on network management data;
the entities and relations are network entities and relations; and
the generated response from the LLM is a network anomaly determination.

11. The medium of claim 9, wherein
each of the response triplets includes a subject entity, an object entity, and a connecting relation linking the subject and object entities according to the response; and
the matching KG triplet is identified when:
the subject entity in the matching KG triplet is similar to the subject entity in the response triplet,
the object entity in the matching KG triplet is similar to the object entity in the response triplet, and
the connecting relation in the matching KG triplet is similar to the connecting relation in the response triplet,
wherein the similarity is determined based on feature representations of the subject and the object entities and the connecting relations in both the response triplet and the matching KG triplet.

12. The medium of claim 8, wherein the determining the semantic similarity between the response triplet and the at least one matching KG triplet comprises:
determining, with respect to each of the at least one matching KG triplet, semantic similarity between the response triplet and the matching KG triplet;
aggregating the semantic similarities determined with respect to different matching KG triplets to derive the semantic similarity between the response triplet and relevant ground truth facts represented by the at least one matching KG triplet.

13. The medium of claim 8, wherein the evaluating the response comprises:
accessing one or more semantic similarities, each of which is determined between each of the one or more response triplets and at least one matching KG triplet;
aggregating the one or more semantic similarities to generate an overall semantic similarity representing the assessment of the response;
creating the explanation for the assessment based on at least one of
the one or more semantic similarities associated with the one or more response triplets, and
the semantic similarity between each of the one or more response triplets and each of its matching KG triplet.

14. The medium of claim 13, wherein the explanation for the assessment is further created based on the semantic similarity between each part of each of the one or more response triplets and the corresponding part of each matching KG triplet.

15. A system comprising:
a knowledge graph constructor implemented by a processor and configured for:
receiving information representing ground truth,
detecting entities and relations from the information, and
constructing a knowledge graph (KG) based on knowledge triplets, each of which characterizes a relation connecting two of the entities in the information and represents a ground truth fact; and
a large language model (LLM) response evaluator implemented by a processor and configured for:
receiving an input query,
generating, via a previously trained LLM, a response with respect to the input query,
identifying, from the response, one or more response triplets, each of which includes two entities via a relation,
with respect to each of the one or more response triplets,
determining, if at least one matching KG triplet exists in the knowledge graph, semantic similarity between the response triplet and the at least one matching KG triplet,
evaluating the response based on the semantic similarities between the one or more response triplets and respective matching KG triplets to generate an assessment, and
providing the response with the assessment including an explanation of the assessment obtained based on the semantic similarity between each response triplet and its matching knowledge triplet.

16. The system of claim 15, wherein the constructing the knowledge graph comprises:
with respect to the entities and the relations detected from the information,
recognizing a subject entity and an object entity from the detected entities that are related according to one of the detected relations, and
creating a KG triplet with the subject entity, the relation that connects the subject and object entities, and the object entity; and
forming the knowledge graph based on the KG triplets.

17. The system of claim 15, wherein
the LLM is trained based on network management data;
the entities and relations are network entities and relations; and
the generated response from the LLM is a network anomaly determination.

18. The system of claim 16, wherein
each of the response triplets includes a subject entity, an object entity, and a connecting relation linking the subject and object entities according to the response; and
the matching KG triplet is identified when:
the subject entity in the matching KG triplet is similar to the subject entity in the response triplet,
the object entity in the matching KG triplet is similar to the object entity in the response triplet, and
the connecting relation in the matching KG triplet is similar to the connecting relation in the response triplet,
wherein the similarity is determined based on feature representations of the subject and the object entities and the connecting relations in both the response triplet and the matching KG triplet.

19. The system of claim 15, wherein the determining the semantic similarity between the response triplet and the at least one matching KG triplet comprises:
determining, with respect to each of the at least one matching KG triplet, semantic similarity between the response triplet and the matching KG triplet;
aggregating the semantic similarities determined with respect to different matching KG triplets to derive the semantic similarity between the response triplet and relevant ground truth facts represented by the at least one matching KG triplet.

20. The system of claim 15, wherein the evaluating the response comprises:
accessing one or more semantic similarities, each of which is determined between each of the one or more response triplets and at least one matching KG triplet;
aggregating the one or more semantic similarities to generate an overall semantic similarity representing the assessment of the response;
creating the explanation for the assessment based on at least one of
the one or more semantic similarities associated with the one or more response triplets, and
the semantic similarity between each of the one or more response triplets and each of its matching KG triplet, wherein.
the explanation for the assessment is created based on the semantic similarity between each part of each of the one or more response triplets and the corresponding part of each matching KG triplet.
